(19) United States
(12) Patent Application Publication
(10) Pub. No.: US 2007/0278817 A1
(43) Pub. Date: Dec. 6, 2007

(54) Clear plastic convering to protect cars

(76) Inventor: Gregg R. Dorsey, Portland, ME (US)

Correspondence Address: SUNG I. OH, PROFESSIONAL LAW CORPORATION, 710 QUAIL VALLEY LANE, WEST COVINA, CA, 91791, US

(21) Appl. No.: 11/444,229

(22) Filed: May 30, 2006

(51) Int. Cl. B60J 11/00

(52) U.S. Cl. 296/136.07

(57) ABSTRACT

A shield that comes in a web and which is easily cut and customized to the desired shape and size to protect any particular part of the vehicle. The shield can be multilayered to protect the finish of the vehicle from nicks as well as from UV rays.

### TECHNICAL FIELD OF THE INVENTION

The present invention relates to the general art of motor vehicles, and to the particular field of accessories for protecting the finish of motor vehicles.

### BACKGROUND OF THE INVENTION

The cost of vehicles such as automobiles, pickup trucks and sport utility vehicles has continued to increase, thereby increasing the desire of owners of these vehicles to maintain them in good condition over a long useful life. Many vehicles, particularly pickup trucks and vans, are operated in recreational activities, such as hunting, fishing, camping, and exploring, in areas that are uncleared or partially cleared of vegetation that is sufficiently hard or sharp to scratch and mar the high gloss finish on such vehicles and make their appearance undesirable for daily use. In pursuit of these recreational activities, these vehicles frequently push through areas having no roads and having dense growths of bushes and small trees. The high gloss enamel finish on most vehicles would be essentially destroyed by the scraping and scratching of the bushes and trees encountered in the first trail breaking endeavor.

Still further, large hailstones can reach extreme velocities and transmit and deliver destructive energy to vehicles. Hailstones 10 cm (4 inches) in diameter fall on the average at a speed of 40 meters per second (88 miles per hour). Even small hailstones can cause serious and permanent damage to car and truck sheet metal panels and glass surfaces. In 1991 U.S. property damage from hail was estimated to be in the millions of dollars.

Still further, motor vehicles are typically stored in garages to protect them from damage while not in use. In many situations, however, such an enclosure is unavailable and the motor vehicles must be left unattended where they are subjected to wide varieties of environmental extremes. For example, an automobile which is parked outside for several days may be subjected to moisture from rain, dew, snow or frost; UV radiation and high temperatures from sunlight; low temperatures from conditions at night; abrasion from wind carried particles; and other environmental factors. All of these elements may cause damage to the vehicle. It is known to provide a protective cover to shield the vehicle from the environment in such situations.

Most of the automobile covers on the market are designed to protect the vehicle from dust, rain, and sun light, and most do not adequately protect a vehicle from such hailstones.

While the inventor is aware of devices such as a covering sheet for covering the vehicle body. The covering sheet is used for shielding an automobile and the like from rain or sun rays when it is parked and the automobile cannot travel while being covered therewith. Furthermore, it is generally known that the upper part of the automobile is covered with leather, while the lower part thereof is coated with paint, or its upper and lower parts are coated in colors, patterns or designs different from each other.

Since for such coating, baking method or the like is employed, and the automobile is coated thereby, the color or colors cannot be easily altered. In the case where colors in a desired automobile type are different from one another, sometimes, an automobile of the type coated in the desired color can not be readily purchased because it is inconveniently not on hand. If the automobile body is damaged or rusted, the plate metal must then be reapplied on the automobile surface or its coating must be done all over again. Moreover it is difficult to coat the affected parts and the parts surrounding them in exactly the same color, thereby giving rise to a situation where replacement of parts or recoating of the whole of the automobile body is required, which is expensive and requires a great deal of labor. Moreover, the thus coated automobile surface should be waxed for maintaining its durability and luster, which work also takes time and labor.

Accordingly, there is a great need for a cover which can efficiently protect a vehicle against such destructive scraping and scratching.

While the inventor is aware of nick guards, such as shields that are located on the door of a vehicle, the inventor is not aware of any protective shield that can be modified to fit any part of the vehicle, such as the headlight area, the front grille area, or the like, and which is easy and efficient to apply.

Furthermore, while the inventor is aware of such shields, these shields are standard and may not be suitable for the particular driving needs of the user. The inventor is not aware of any shield that can be customized to the particular demands of his or her specific driving.

Therefore, there is a need for a shield that can be customized for the particular needs of the user and which can be easily and quickly applied to the vehicle being protected.

### SUMMARY OF THE INVENTION

The above-discussed disadvantages of the prior art are overcome by a shield that comes in a web and which is easily cut to the desired shape and size to protect any particular part of the vehicle. The shield can be multilayered to protect the finish of the vehicle from nicks as well as from UV rays.

Using the shield embodying the present invention will permit a user to easily and quickly protect those portions of his or her vehicle that are most exposed to damage from the environment or from nicks. The portions of the vehicle that are in most need of protection for the particular driving that the user will expect can be protected. Thus, the shield embodying the present invention can be easily and quickly customized as needed by the user.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows sheet of the material used in the shield before the material is cut to the requirements of the particular application.

FIG. 2 is a perspective view of a shield embodying the present invention in conjunction with a door of a land vehicle to be protected by the customized shield.

FIG. 3 is a perspective view of a shield embodying the present invention in conjunction with a headlight of a land vehicle to be protected by the customized shield.

FIG. 4 is a sectional view taken along line 4-4 of FIG. 3.

### DETAILED DESCRIPTION OF THE INVENTION

Referring to the figures, it can be understood that the present invention is embodied in a shield 10 for a vehicle such as a car, truck or the like, and which can be cut and shaped to be customized to protect a particular portion of the vehicle whereby the portion or portions of the vehicle that are most likely to be damaged due to the manner the particular owner uses that vehicle can be specifically protected. Shield 10 comprises a web 12. Web 12 comes in indeterminate lengths and widths and is cut to fit the particular part of a vehicle being protected. The web can come in a roll if desired. Web 12 includes a first layer 14 of clear plastic material, a second layer 16 of material which prevents penetration of UV rays, and a third layer 18 of clear plastic material which can be identical to the first layer.

The details of the layers are not important to this invention and will not be claimed or discussed. Those skilled in the art will understand what characteristics the layers have based on the teaching of this disclosure.

Second layer 16 is sandwiched between first layer 14 and third layer 18. Means, such as adhesive layer 20 or the like is used for attaching the web to a motor vehicle. As an example, pressure sensitive adhesive layer such as the one found in office product label may be used as the adhesive layer 20. Alternatively, the web 12 may be applied much like a window tint material, where the area of the vehicle in which the web 12 is to be applied may be first cleaned. The web 12 may then be applied to the cleaned area of the vehicle which is wet, and applied to the vehicle similar to application of window tinting.

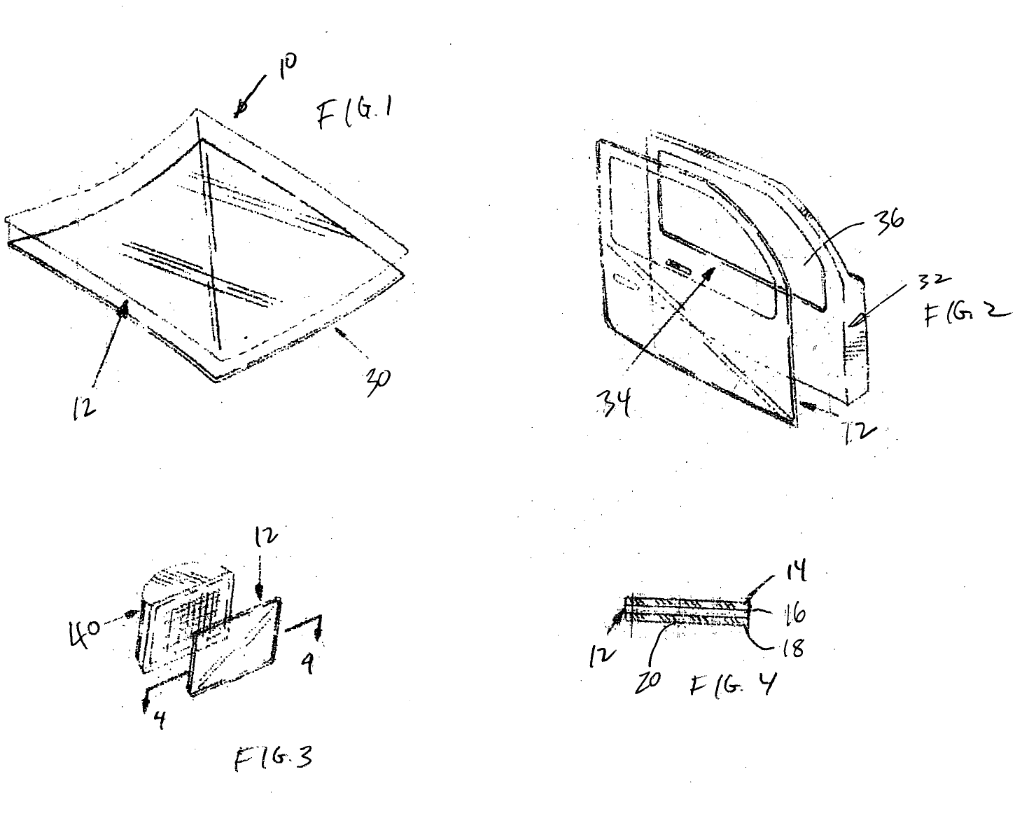

As shown in FIG. 1, web 12 can be mounted on a hood 30 of a vehicle, or as shown in FIG. 2, web 12 can be mounted on a door 32 of a vehicle. In the case of a vehicle door, the web is cut to match the size of the door, and then a cutout 34 is defined in the web to match the size and shape of window 36 of the door. As shown in FIG. 3, web 12 can be used to protect a headlight 40 of the vehicle, in which case the web is cut to correspond to the size and shape of the headlight. The portion of the vehicle being protected is cleaned and then the means for attaching the web to the vehicle is activated and the customized web is applied to the vehicle.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A shield for a vehicle comprising:
A) a web which includes
(1) a first layer of clear plastic material,
(2) a second layer of material which prevents penetration of UV rays, and
(3) a third layer of clear plastic material,
(4) the second layer being sandwiched between the first layer and the third layer; and
B) means for attaching the web to a motor vehicle.

2. A method of protecting a vehicle which includes
A) providing a shield which includes a web having a first layer of clear plastic material, a second layer of material which prevents penetration of UV rays, and a third layer of clear plastic material, the second layer being sandwiched between the first layer and the third layer; and means for attaching the web to a motor vehicle;
B) cutting the shield to a preselected size and shape;
C) cutting portions of the shield to define openings through the shield; and
D) applying the cut shield to the motor vehicle.

3. The method defined in claim 2 wherein the vehicle has a headlight and the shield is cut to conform to the size and shape of the headlight of the vehicle.

4. The method defined in claim 2 wherein the vehicle has a hood and the shield is cut to conform to the size and shape of the hood of the vehicle.
